(19) United States
(12) Patent Application Publication
(10) Pub. No.: US 2019/0331767 A1
(43) Pub. Date: Oct. 31, 2019

(54) CHARGING STATION IDENTIFYING METHOD, DEVICE, AND ROBOT

(71) Applicant: UBTECH Robotics Corp, Shenzhen (CN)

(72) Inventors: Youjun Xiong, Shenzhen (CN); Gaobo Huang, Shenzhen (CN); Wenxue Xie, Shenzhen (CN)

(21) Appl. No.: 16/116,952

(22) Filed: Aug. 30, 2018

(30) Foreign Application Priority Data
Apr. 27, 2018 (CN) 201810393304.7

(51) Int. Cl. G01S 7/41; G01S 13/88

(52) U.S. Cl. CPC G01S 7/41; G01S 13/881

(57) ABSTRACT

The present disclosure relates to robot identifying technology, and particularly tot method, a device, and a robot for identifying a charging station. The method includes: obtaining radar data produced by scanning a charging station through a radar of a robot; determining whether a second data block meeting a second preset condition exists in the radar data, in response to a first data block meeting a first preset condition existing in the radar data; and determining a charging station identified by the robot, in response to the second data block meeting a second preset condition existing in the radar data. Through the present disclosure, a robot can identify the charging station accurately from a remote place, and expand the identification range of the recharging of the robot.

### CROSS REFERENCE TO RELATED APPLICATIONS

This application claims priority to Chinese Patent Application No. 201810393304.7, filed Apr. 27, 2018, which is hereby incorporated by reference herein as if set forth in its entirety.

### BACKGROUND

### 1. Technical Field

The present disclosure relates to robot identification technology, and particularly to a method, a device, and a robot for identifying a charging station.

### 2. Description of Related Art

With the development of science and technology as well as the improvement of people's living standards, a variety of intelligent mobile robots have appeared in the markets. For the realization of robotic self-charging technology, more and more robots adopt the radar recharging technology.

At present, when a robot adopts the radar recharging technology, the characteristics of a radar itself and the offset angle between the robot and a charging station will cause limitations. For the radars with high angular resolution and good data stability, they have difficulty in mass-produce since their high costs. For the radars with relatively low price, they have low angular resolution and poor data stability.

When the robot performs automatic recharging, it is usually navigated to the vicinity of a charging station, and then starts to dock at the charging station. Since the navigation of the robot usually has a certain error, the robot may be in different positions in front of the charging station. Sometimes it may be closer, and sometimes it may be farer; sometimes it may be in directly front of the charging station, and sometimes it may be biased. For the radars with lower price, they may have relatively large data jitters and fewer scanning points will be obtained, hence the determination data is not accurate enough and causes the failure in identifying the charging station. If more scanning points are used for identification, the robot can only identify the charging station at the positions which are nearer and relatively positive, which results in the smaller identification range for some robot radar recharging.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a schematic diagram of a radar robot according to an embodiment of the present disclosure.

FIG. 2 is a flow chart of a charging station identifying method according to an embodiment of the present disclosure.

FIG. 3 is a schematic diagram of radar scanning data according to an embodiment of the present disclosure.

FIG. 4 is a flow chart of another charging station identifying method according to an embodiment of the present disclosure.

FIG. 5 is a flow chart of a method for identifying and docking at a charging station according to an embodiment of the present disclosure.

FIG. 6 is a schematic diagram of a charging station identifying device according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “a,” “an,” and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

For the purpose of describing the technical solutions of the present disclosure, the following describes through specific embodiments.

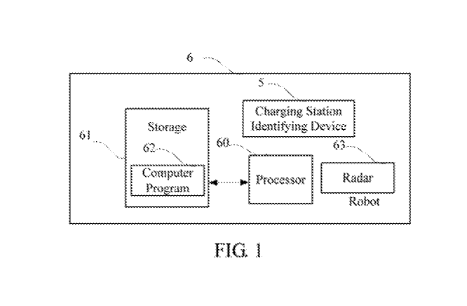

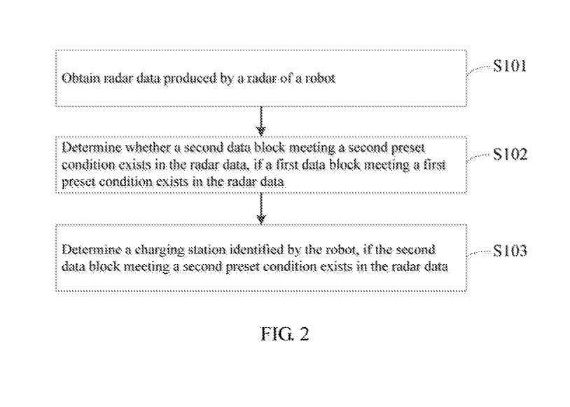

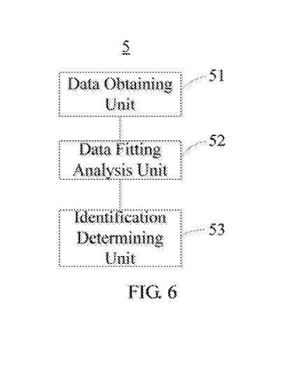

FIG. 1 is a schematic diagram of a radar robot according to an embodiment of the present disclosure. For the convenience of description, only the parts related to this embodiment are shown. As shown in FIG. 1, in this embodiment, a radar robot 6 includes a charging station identifying device 5 (see FIG. 6), a processor 60, a storage 61, a computer program 62 stored in the storage 61 (e.g., a memory) and executable on the processor 60, for example, a Linux program, and a radar 63. When the processor 60 executes the computer program 62, the steps in each of the above-mentioned embodiments of the charging station identifying method, for example, steps S101-S103 as shown in FIG. 2, are implemented. Alternatively, when the processor 60 executes the computer program 62, the functions of each of the modules units in the above-mentioned device embodiments, for example, the functions of the units 51-53 as shown in FIG. 6, are implemented.

Exemplarily, the computer program 62 may be divided into one or more modules/units, and the one or more modules units are stored in the storage 61 and executed by the processor 60 to realize the present disclosure. The one or more modules/units may be a series of computer program instruction sections capable of performing a specific function, and the instruction sections are for describing the execution process of the computer program 62 in the radar robot 6.

The radar robot 6 may include, but is not limited to, the processor 60 and the storage 61. It can be understood by those skilled in the art that FIG. 6 is merely an example of the radar robot 6 and does not constitute a limitation on the robot 6, and may include more or fewer components than those shown in the figure, or a combination of some components or different components. For example, the radar robot 6 may further include an input/output device, a network access device, a bus, and the like.

The processor 60 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 61 may be an internal storage unit of the radar robot 6, for example, a hard disk or a memory of the radar robot 6. The storage 61 may also be an external storage device of the radar robot 6, for example, a plug-in hard disk, a smart media card (SMC), a secure digital (SD) card, flash card, and the like, which is equipped on radar robot 6. Furthermore, the storage 61 may further include both an internal storage unit and an external storage device, of the radar robot 6. The storage 61 is configured to store the computer program and other programs and data required by the radar robot 6. The storage 61 may also be used to temporarily store data that has been or will be output.

FIG. 2 is a flow chart of a charging station identifying method according to an embodiment of the present disclosure. In this embodiment, the method is a computer-implemented method executable for a processor. The charging station identifying method is utilized to recharge a robot. As shown in FIG. 2, the method includes the following steps.

S101: obtaining radar data produced by a radar of the robot.

In this embodiment, the radar data refers to one or more data points which are reflected back and detected by the radar of the robot after the radar scans an object (e.g., a charging station).

In addition, in the case of using the same radar and a charging station with a fixed size, the closer the charging station is to the radar, the more the data points are obtained by scanning the charging station; the more direct the charging station faces the radar, the more the data points are obtained by scanning the charging station, and the most data points will be obtained while the radar is positioned in directly front of the charging station.

It should be noted that, the obtained data includes the data of the distance and angle between the scanned charging station and the radar.

Furthermore, after the step 101 that obtaining the radar data produced by the radar of the robot, the method may further include:

filtering the radar data to obtain valid global radar data.

In this embodiment, the data collected by the radar may generally have abnormalities, for example, has a jump or a negative value, and the abnormal data needs to be filtered out to obtain the valid global radar data, thereby avoiding deviation effects on subsequent operation and analysis.

S102: determining whether a second data block meeting a second preset condition exists in the radar data, if a first data block meeting a first preset condition exists in the radar data.

In this embodiment, a data operation unit of the robot sequentially obtains a preset number of data blocks since the first radar data is collected. For example, if the collected radar data has a total of 10*N, N of the data blocks are sequentially obtained to perform a fitting operation, and it is determined that whether N of the data blocks meets the first preset condition, in which the first preset condition is that a fitting operation result of the first data block is less than a preset first threshold. For instance, when the radius of the arc of the charging station is 0.27 m, the sum of the square of the difference between the center of the charging station and each point on the arc of the charging station which is calculated through fitting operation will be less than the first threshold of 0.001. The first data block includes a smaller number of the data points which are selected from the radar data, for example, 12 or 10 data points may be selected to compose the first data block. The number of the first data block may be selected according to the specific collected radar data. The number of the data points which can be scanned will differ while the distance between the robot and the charging station differs. The fitting operation is performed on the first data blocks, of a smaller number and it is determined that whether the first data block meeting the first preset condition exists or not, which is capable of preliminarily identifying the charging station which may exist in a relatively large range. The second preset condition is that a fitting operation result of the second data block is less than a preset second threshold.

In addition, the fitting operation includes: performing circle fitting on the data points of the first data block by using a least squares method, obtaining an error of the radius of a fitted circle with respect to the radius of the arc of the charging station as well as a covariance of the radius of the fitted circle and the radius of the arc of the charging station, and performing the detection and determination on the fitted circle of the first data block. If the charging station has other shapes, other fitting operation methods may be applied to the first data block, and an error of the fitting result with respect to the shape of the charging station may be obtained to determine the availability of the first data block.

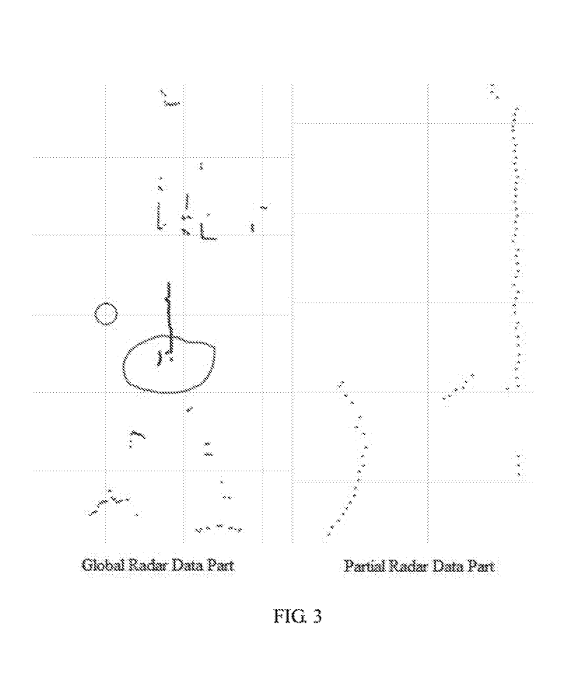

If the result of the fitting operation of the first data block is less than the preset first threshold, it is determined that whether the second data block meeting the second preset condition exists in the radar data, where the second data block includes a specified number of data points in the radar data in addition to the data points in the first data block. The second data block may be formed by adding a specified number of data points in the radar data on the basis of (the data points of) the first data block. For instance, if an index position of the current first data block is i, the index position i is used as a starting point, and the number of the data points in the first data block is increased to a predefined maximum number of data points such as 60 data points. The second data block is determined that whether it meets the second preset condition or not by determining that whether the result of the fitting operation of the second data block is less than the second threshold or not, so as to fine identifies the charging station in a smaller range. FIG. 3 is a schematic diagram of radar scanning data according to an embodiment of the present disclosure. For the global radar data, since the real position of the charging station cannot be confirmed, it is necessary to sequentially take a smaller specified number of data blocks from the radar data to perform a fitting operation thereon. For example, as shown in FIG. 3, in the partial data part that on the right side of FIG. 3, the 20 (radar scanning data) points in the lower left corner of the part is a partial enlargement view of the data after the radar scans the charging station, and the 12 points of the upper part of the 20 points of the charging station are selected to perform the fitting operation thereon, so as to perform the preliminary analysis and determination on the charging station.

In addition, the first operation result includes a first radius difference and a first radius covariance.

It should be noted that, the first threshold is greater than the second threshold.

Furthermore, the step 102 that determining whether the second data block meeting the second preset condition exists in the radar data, if the first data block meeting the first preset condition exists in the radar data may include:

A1: performing a first fitted circle calculation on the first data block using a least squares method;

A2: obtaining a first radius difference between a first fitting circle radius and the radius of the arc of the charging station as well as a first radius covariance of the first fitting circle radius and the radius of the arc of the charging station; and

A3: determining whether the second data block meeting the second preset condition exists in the radar data, if the first radius difference is smaller than a preset first error and the first radius covariance is smaller than a preset first overall error.

In this embodiment, a circle fitting operation is performed on the selected first data block by using the least squares method, and the radius of the fitted circle is compared with the actual radius of the arc of the charging station, thereby obtaining the first radius difference and the first radius covariance. If the first radius difference is smaller than the preset first error, and the first radius covariance is smaller than the preset first overall error, it is determined that the first data block meets the first preset condition, and it continues to determine whether the second data block meeting the second preset condition exists in the radar data or not.

In addition, the first error and the first overall error are set according to the shape characteristics of the charging station. For example, for the arc-shape charging station, the radius information of the arc-shape charging station is obtained, and the errors which has a relatively greater value may be used (in accordance with the actual radius of the arc of the charging station) for guaranteeing the stability of the data before the preliminary identification of the charging station is performed based on the first data block.

Furthermore, the step A3 that determining whether the second data block meeting the second preset condition exists in the radar data, if the first radius difference is smaller than the preset first error and the first radius covariance is smaller than the preset first overall error includes:

B1: adding a specified number of data points in the radar data based on the first data block to obtain the second data block;

B2: performing a second fitted circle calculation on the second data block using a least squares method;

B3: obtaining a second radius difference between the second fitting circle radius and the radius of the arc of the charging station, and a second radius covariance of the second fitting circle radius and the radius of the arc of the charging station; and

B4: determining whether the second radius difference is smaller than a second error and whether the second radius covariance is smaller than a second overall error.

In this embodiment, if the first data block meeting the preset first condition exists, the existence of the charging station may be preliminarily confirmed, and it is necessary to continue to select the second data block for further identifying the preliminarily confirmed charging station. The specified number of data points (in the radar data) are added on the basis of the first data block. For instance, if the first data block includes 15 data points, and a current index position is i, the index position i is used as a starting point, then the number of the data points is increased to 45 data points, and totally 60 data points are obtained as the second data block for performing the analysis and determination. The second fitted circle calculation is performed on the second data block using the least squares method to obtain the radius of a second fitted circle, and the radius of the second fitted circle and the radius of the charging station are compared to obtain the second radius difference as well as the second radius covariance of the radius of the second fitting circle and the radius of the arc of the charging station. It is determined that whether the second radius difference is smaller than the second error or not and whether the second radius covariance is smaller than the second overall error or not where the second error which has a relatively less value than the first error is set according to the actual radius of the arc of the charging station, and the second overall error which has a relatively less value than the first overall error is a covariance set according, to the arc of the charging station. The charging operation is further identified in an accurate manner through the fitting operation of the second data block.

It should be noted that, the second radius difference and the second radius covariance which are obtained based on the second data block may be within the ranges of the preset second error and the preset second overall error, or the result of the operations may be not within the ranges due to the selected data points in the second data block is too many.

S103: determining a charging station identified by the robot, if the second data block meeting a second preset condition exists in the radar data.

In this embodiment, the preset second condition is that the result of the fitting operation of the second data block is less than the preset second threshold. The second threshold is greater than the first threshold. Since the number of the data points in the second data block has been increased, the result of the fitting operation will be closer to the actual value of the charging station, and the operation result is more likely to be not exceeding the second threshold. If the second data block meets the preset second condition, and the operation result is less than the preset second threshold, it is confirmed that the charging station which meets the requirements is identified. For example, if the charging station has an arc shape, the error of the radius of the circle obtained by the fitting operation of the second data block with respect to the radius of the arc of the charging station will be small, and it is determined that the charging station which meets the size requirement for the robot is identified.

Furthermore, the step S103 that determining the charging station identified by the robot, if the second data block meeting the second preset condition exists in the radar data may include:

determining the charging station identified by the robot, if the second radius difference is smaller than the second error and the second radius covariance is smaller than the second overall error.

In this embodiment, a fitting circle operation is performed on the second data block using the least squares method to obtain the radius of the second fitting circle, and the second radius difference and the second radius covariance are obtained based on the radius of the second fitting circle and the radius of the arc of the charging station. If the second radius difference is smaller than the preset second error, and the second radius covariance is smaller than the preset second overall error, it is confirmed that the charging station meeting the requirements is identified or a charging station which meets the requirements exists.

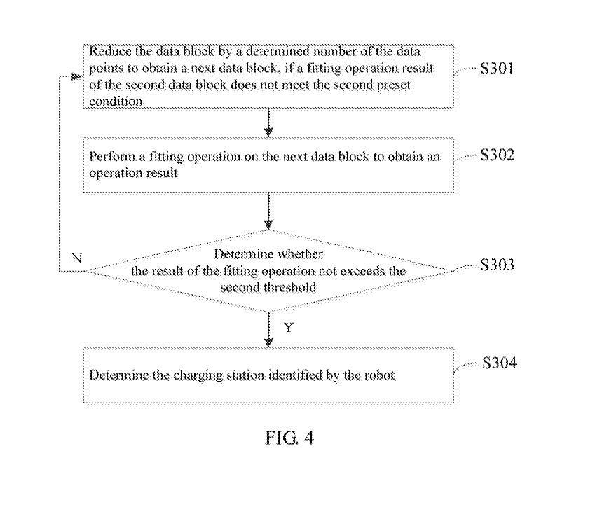

FIG. 4 is a flow chart of another chanting station identifying method according to an embodiment of the present disclosure. As shown in FIG. 4, after step S102 that determining whether the second data block meeting the second preset condition exists, if the first data block meeting the first preset condition exists in the radar data further includes:

S301: reducing the data block by a determined number of the data points to obtain a next data block, if a fitting operation result of the second data block does not meet the second preset condition.

In this embodiment, if the current number of the data points in the second data blocks does not meet the preset second condition, it is determined that the charging station meeting the requirements had not been found based on the current number of the data points in the second data block. If the current number of the data points in the second data block is greater than the sum of the data points in the first data block and a preset data block (i.e., the number of the data points in the first data block during the preliminary identification), the current data block is sequentially reduced by the determined number of the data points to obtain the next data block for the next line identification. In which, the preset data block and the reduced number of data points may be set according to a specific application scenario and the collected amount of the radar data, which is not limited herein. For example, if the second data block includes 60 data, the second data block is reduced by 5 or 10 data in order, and then there are 55 or 50 data for the next fitting operation.

In addition, if the operation result obtained by operating based on the second data block exceeds the preset second threshold, and the number of the data points in the second data block is less than the sum of the data points in the first data block and the data points in the preset data block, it is determined that, the preliminary identified charging station is false. If the current data index bit is j, the selection of the new first data block is started from the j+1-th data so as to perform the preliminary analysis and identification as well as the subsequent fine analysis and identification.

S302: performing a fitting operation on the next data block to obtain an operation result.

This step is the sou as the determination process of step S102 that determining whether the second data block meeting the second preset condition exists in the radar data. For details, refer to the related description of step S102, which are not described herein.

S303: determining whether the result of the fitting operation not exceeds the second threshold.

In this embodiment, the fitting circle operation is performed on the next data block with the reduced number of the data points by using the least squares method, thereby obtaining the operation result. It is determined that whether a data block meeting the preset second condition exists or not, and determined that whether the result of the fitting operation does not exceed the second threshold.

S304: determining the charging station identified by the robot, if the result of the fitting operation does not exceed the second threshold.

This step is the same as step S103. For details, refer to the related description of step S103, which are not described herein.

S305: performing another fitting operation after reducing the determined number of the data points from the data block, and determining whether the result of the another fitting operation not exceeds the second threshold, if the result of the fitting operation exceeds the second threshold.

In this embodiment, if the result of the fitting operation is still exceeding the second threshold, the current data block is continuously reduced by the specified number of data points. After 5 or 10 data is reduced, the fitting operation continues is performed on the current data block, the operation result is continuously compared with the second threshold, and the above-mentioned steps are repeated until the data block that meets the preset second condition is found.

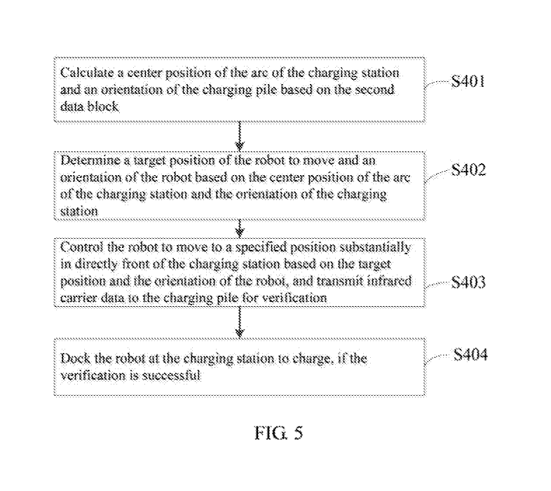

FIG. 5 is a flow chart of a method for identifying and docking at a charging station according to an embodiment of the present disclosure. As shown in FIG. 5, after step S103 that determining the charging station identified by the robot, if the second data block meeting the second preset condition exists in the radar data, the method further includes:

S401: calculating a center position of the arc of the charging station and an orientation of the charging station based on the second data block.

In this embodiment, the center position of the charging station is obtained based on the second data block in the radar data, and the orientation of the charging station is determined since the center position of the charging station is determined.

S402: determining a target position of the robot to move and an orientation of the robot based on the center position of the arc of the charging station and the orientation of the charging station.

In this embodiment, if the radius of the arc of the charging station coincides with the radius of a chassis of the robot, and a conductive sheet or a conductive wheel of the robot is directly behind the robot, the position of the renter of the charging station may be the target position of the robot, and the directly front of the robot is identical to the directly front of the charging station.

S403: controlling the robot to move to a specified position substantially in directly front of the charging station based on the target position and the orientation of the robot, and transmitting infrared carrier data to the charging station for verification.

In this embodiment, the robot is controlled to move to the specified position in directly front of the charging station, for example, a position in directly front and has 0.4 meters' distance from the charging station, based on the determined target position and orientation of the robot, and an infrared receiving device of the robot is aligned with the charging station to transmit infrared carrier data for verification, thereby further identifying and confirming the charging station.

S404: docking the robot at the charging station to charge, if the verification is successful.

In this embodiment, if the infrared carrier data is detected and the value of the carrier is equal to the value of the infrared carrier transmitted by the charging station, the infrared carrier data will be successfully verified, the chassis of the robot continues to be moved and is docked at the charging station for charging and the radar recharging automatic docking is successful, and then the process of the robot radar scanning automatic docking ends. If the verification of the infrared carrier data fails, the radar recharging automatic docking fails accordingly.

It should be noted that, other verification schemes that can be easily conceived by those skilled in the art within the technical scope disclosed in the present disclosure should also be within the scope of the present disclosure, which will not be described herein.

Through this embodiment, the data of the charging station which is currently scanned by the radar is obtained, and the data is filtered to obtain the effective global radar data. The matching and analysis is performed according to the frontal feature shape of the charging station and the global radar data, which includes the preliminary fitting operation identification analysis and the fine fitting operation identification analysis, so as to confirm that the charging station meets the requirements is identified so that the robot can accurately scan, identify, and dock at the charging station from a relatively remote place, thereby reducing the requirement for navigation accuracy, improving the intelligence of product, and expanding the identification range of robot radar recharging.

It should be understood that, the sequence of the serial number of the steps in the above-mentioned embodiments does not represent the execution order. The order of the execution of each process should be determined by its function and internal logic, and should not cause a limitation to the implementation process of the embodiments of the present disclosure.

FIG. 6 is a schematic diagram of a charging station identifying device according to an embodiment of the present disclosure. For convenience of description, only parts related to this embodiment are shown.

As shown in FIG. 6, a charging station identifying device 5 includes:

a data obtaining unit 51 configured to obtain radar data produced by a radar of the robot;

a data fitting analysis unit 52 configured to determine whether a second data block meeting a second preset condition exists in the radar data, if a first data block meeting a first preset condition exists in the radar data; and

an identification determining unit 53 configured to determine a charging station identified by the robot, if the second data block meeting a second preset condition exists in the radar data.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units ma or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program, codes, a recording medium, a USB flash drive, a portable hard disk, a magnetic disk, an optical disk, a computer memory, a read-only memory (ROM), a random access memory (RAM) electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes each of the above-mentioned embodiments may still be modified, or some of the technical features may be equivalently replaced, these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented charging station identifying method for a robot comprising a radar, comprising executing on a processor steps of:
obtaining radar data produced by the radar of the robot;
determining whether a second data block meeting a second preset condition exists in the radar data, in response to a first data block meeting a first preset condition existing in the radar data; and
determining a charging station identified by the robot, in response to the second data block meeting a second preset condition existing in the radar data;
wherein, the first preset condition is a fitting operation result of the first data block being less than a preset first threshold, and the second preset condition is a fitting operation result of the second data block being less than a preset second threshold, the first threshold is greater than the second threshold, the first data block includes a preset number of data points in the radar data, and the second data block includes the preset number of the data points in the first data block and a specified number of the other data points in the radar data.

2. The method of claim 1, wherein the step of determining whether the second data block meeting the second preset condition exists in the radar data, in response to the first data block meeting the first preset condition existing in the radar data comprises:
performing a first fitted circle calculation on the first data block using a least squares method;
obtaining a first radius difference between a first fitting circle radius and the radius of the arc of the charging station as well as a first radius covariance of the first fitting circle radius and the radius of the arc of the charging station; and
determining whether the second data block meeting the second preset condition exists in the radar data, in response to the first radius difference being smaller than a preset first error and the first radius covariance being smaller than a preset first overall error.

3. The method of claim 2, wherein the step of determining whether the second data block meeting the second preset condition exists in the radar data, in response to the first radius difference being smaller than the preset first error and the first radius covariance being smaller than the preset first overall error comprises:
adding a specified number of data points in the radar data based on the first data block to obtain the second data block;
performing a second fitted circle calculation on the second data block using a least squares method;
obtaining a second radius difference between the second fitting circle radius and the radius of the arc of the charging station, and a second radius covariance of the second fitting circle radius and the radius of the arc of the charging station; and
determining whether the second radius difference is smaller than a second error and whether the second radius covariance is smaller than a second overall error.

4. The method of claim 3, wherein the step of determining the charging station identified by the robot, in response to the second data block meeting the second preset condition existing in the radar data comprises:
determining the charging station identified by the robot, in response to the second radius difference being smaller than the second error and the second radius covariance being smaller than the second overall error.

5. The method of claim 1, wherein after the step of determining whether the second data block meeting the second preset condition exists in the radar data, in response to the first data block meeting the first preset condition existing in the radar data comprises:
reducing the data block by a determined number of the data points to obtain a next data block, in response to a fitting operation result of the second data block being not meeting the second preset condition;
performing a fitting operation on the next data block to obtain an operation result;
determining whether the result of the fitting operation not exceeds the second threshold;
determining the charging station identified by the robot, in response to the result of the fitting operation being not exceeding the second threshold; and
performing another fitting operation after reducing the determined number of the data points from the data block, and determining whether the result of the another fitting operation not exceeds the second threshold, in response to the result of the fitting operation being exceeding the second threshold.

6. The method of claim 1, wherein after the step of obtaining the radar data produced by the radar of the robot comprises:
filtering the radar data to obtain valid global radar data.

7. The method of claim 1, wherein after the step of determining the charging station identified by the robot, in response to the second data block meeting the second preset condition existing in the radar data comprises:
calculating a center position of the arc of the charging station and an orientation of the charging station based on the second data block;
determining a target position of the robot to move and an orientation of the robot based on the center position of the arc of the charging station and the orientation of the charging station;
controlling the robot to move to a specified position substantially in directly front of the charging station based on the target position and the orientation of the robot, and transmitting infrared carrier data to the charging station for verification; and
docking the robot at the charging station to charge, in response to be verification being successful.

8. A charging station identifying device for a robot, comprising:
a data obtaining unit configured to obtain radar data produced by scanning a charging station through a radar of the robot;
a data fitting analysis unit configured to determine whether a second data block meeting a second preset condition exists in the radar data, in response to a first data block meeting a first preset condition existing in the radar data; and
an identification determining unit configured to determine a charging station identified by the robot, in response to the second data block meeting a second preset condition existing in the radar data.

9. The device of claim 8, wherein the data obtaining unit is configured to:
perform a first fitted circle calculation on the first data block using a least squares method;
obtain a first radius difference between a first fitting circle radius and the radius of the arc of the charging station as well as a first radius covariance of the first fitting circle radius and the radius of the arc of the charging station; and
determine whether a second data block meeting the second preset condition exists in the radar data, in response to the first radius difference being smaller than a preset first error and the first radius covariance being smaller than a preset first overall error.

10. The device of claim 9, wherein the data obtaining unit is configured to:
adding a specified number of data points in the radar data based on the first data block to obtain the second data block;
performing a second fitted circle calculation on the second data block using a least squares method;
obtaining a second radius difference between the second fitting circle radius and the radius of the arc of the charging station, and a second radius covariance of the second fitting circle radius and the radius of the arc of the charging station; and
determining whether the second radius difference is smaller than a second error and whether the second radius covariance is smaller than a second overall error.

11. The device of claim 10, wherein the identification determining unit is configured to:
determine the charging station identified by the robot, in response to the second radius difference being smaller than the second error and the second radius covariance being smaller than the second overall error.

12. The device of claim 1, wherein the data fitting analysis unit is further configured to:
reduce the data block by a determined number of the data points to obtain a next data block, in response to a fitting operation result of the second data block being not meeting the second preset condition;
perform a fitting operation on the next data block to obtain an operation result;
determine whether the result of the fitting operation not exceeds the second threshold;
determine the charging station identified by the robot, in response to the result of the fitting operation being not exceeding the second threshold; and
perform another fitting operation after reducing the determined number of the data points from the data block, and determine whether the result of the another fitting operation not exceeds the second threshold, in response to the result of the fitting operation being exceeding the second threshold.

13. The device of claim 1, wherein the data obtaining unit is further configured to:
filter the radar data to obtain valid global radar data.

14. The device of claim 1, wherein the data fitting analysis unit is further configured to:
calculate a center position of the arc of the charging station and an orientation of the charging station based on the second data block;
determine a target position of the robot to move and an orientation of the robot based on the center position of the arc of the charging station and the orientation of the charging station;
control the robot to move to a specified position substantially in directly front of the charging station based on the target position and the orientation of the robot, and transmit infrared carrier data to the charging station for verification; and
dock the robot at the charging station to charge, in response to the verification being successful.

15. A robot, comprising a memory, one or more processors, and one or more computer programs, wherein the one or more computer programs are stored in the memory and configured to be executed by the one or more processors, the one or more programs comprise:
instructions for obtaining radar data produced by scanning a charging station through a radar of the robot;
instructions for determining whether a second data block meeting a second preset condition exists in the radar data, in response to a first data block meeting a first preset condition existing in the radar data; and
instructions for determining a charging station identified by the robot, in response to the second data block meeting a second preset condition existing in the radar data.

16. The robot of claim 15, wherein the instructions for determining whether the second data block meeting the second preset condition exists in the radar data, in response to the first data block meeting the first preset condition existing in the radar data comprises:
instructions for performing a first fitted circle calculation on the first data block using a least squares method;
instructions for obtaining a first radius difference between a first fitting circle radius and the radius of the arc of the charging station as well as a first radius covariance of the first fitting circle radius and the radius of the arc of the charging station; and
instructions for determining whether the second data block meeting the second preset condition exists in the radar data, in response to the first radius difference being smaller than a preset first error and the first radius covariance being smaller than a preset first overall error.

17. The robot of claim 16, wherein the instructions for determining whether the second data block meeting the second preset condition exists in the radar data, in response to the first radius difference being smaller than the preset first error and the first radius covariance being smaller than the preset first overall error comprises:
instructions for adding a specified number of data points in the radar data based on the first data block to obtain the second data block;
instructions for performing a second fitted circle calculation on the second data block using a least squares method;
instructions for obtaining a second radius difference between the second fitting circle radius and the radius of the arc of the charging station, and a second radius covariance of the second fitting circle radius and the radius of the arc of the charging station; and
instructions for determining whether the second radius difference is smaller than a second error and whether the second radius covariance is smaller than a second overall error.

18. The robot of claim 17, wherein the instructions for determining the charging station identified by the robot, in response to the second data block meeting the second preset condition existing in the radar data comprises:
instructions for determining the charging station identified by the robot, in response to the second radius difference being smaller than the second error and the second radius covariance being smaller than the second overall error.

19. The robot of claim 15, wherein the one or more programs further comprises:
instructions for reducing the data block by a determined number of the data points to obtain a next data block, in response to a fitting operation result of the second data block being not meeting the second preset condition;
instructions for performing a fitting operation on the next data block to obtain an operation result;
instructions for determining whether the result of the fitting operation not exceeds the second threshold;
instructions for determining the charging station identified by the robot, in response to the result of the fitting operation being not exceeding the second threshold; and
instructions for performing another fitting operation after reducing the determined number of the data points from the data block, and determining whether the result of the another fitting operation not exceeds the second threshold, in response to the result of the fitting operation being exceeding the second threshold.

20. The robot of claim 15, wherein the one or more programs further comprises:
instructions for filtering the radar data to obtain valid global radar data.
